(19) United States
(12) Patent Application Publication
(10) Pub. No.: US 2023/0306847 A1
(43) Pub. Date: Sep. 28, 2023

(54) COMMUNITY BASED PARKING SYSTEM

(71) Applicant: Pado-Community GmbH, Worms (DE)

(72) Inventors: Domenico Solazzo, Worms (DE); Vincent Roger Albert Ghislain Mauroit, Worms (DE); Juergen Andreas Peters, Worms (DE); Thea Feuerstein, Worms (DE)

(73) Assignee: Pado-Community GmbH, Worms (DE)

(21) Appl. No.: 18/018,865

(22) PCT Filed: Jul. 30, 2021
(86) PCT No.: PCT/IB2021/057007

§ 371 Date: Jan. 30, 2023

Related U.S. Application Data
(60) Provisional application No. 63/059,603, filed on Jul. 31, 2020.

(51) Int. Cl. G08G 1/14; G08G 1/01; G06Q 10/02

(52) U.S. Cl. CPC G08G 1/148; G08G 1/012; G08G 1/0141; G06Q 10/02

(57) ABSTRACT

A method for determining traffic in a geographic area is shown. The method includes generating parking reservation data corresponding to a plurality of peer-to-peer parking reservations, each of the peer-to-peer parking reservations comprising a reservation by a user of the traffic management system of a parking spot offered by another user of the traffic management system. The method further includes determining a subset of the peer-to-peer parking reservations associated with the geographic area. The method further includes generating an indication of the traffic in the geographic area using the parking reservation data for the subset of the peer-to-peer parking reservations associated with the geographic area.

### CROSS-REFERENCE TO RELATED APPLICATION

This application claims the benefit and priority of U.S. Provisional Patent Application No. 63/059,603, filed Jul. 31, 2020, which is incorporated herein by reference in its entirety.

### BACKGROUND

The present application relates to parking systems. More particularly, the present application relates to community-based parking systems for facilitating peer-to-peer parking reservations.

Finding parking spots can be difficult and frustrating for drivers, particularly during congested conditions. Searching for a parking spot can result in unnecessary fuel consumption, emissions and wasted time and can make it difficult to arrive at a destination at a desired time. There exists a need for a system that provides greater availability and visibility of current and future parking vacancies and connects individuals with any, both public as privately owned, available parking to those with parking needs.

### SUMMARY

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

One implementation of the present disclosure is a method for determining traffic in a geographic area. The method includes generating parking reservation data corresponding to a plurality of peer-to-peer parking reservations, each of the peer-to-peer parking reservations including a reservation by a user of a traffic management system of a parking spot offered by another user of the traffic management system. The method further includes determining a subset of the peer-to-peer parking reservations associated with the geographic area. The method further includes generating an indication of the traffic in the geographic area using the parking reservation data for the subset of the peer-to-peer parking reservations associated with the geographic area.

In some embodiments, the parking reservation data includes a timeframe, both current and future, and a location for each of the peer-to-peer parking reservations. In some embodiments, the method further includes determining a first timeframe for the indication of the traffic. The method further includes determining the subset of the peer-to-peer parking reservations by filtering the peer-to-peer parking reservations to identify the peer-to-peer parking reservations having locations associated with the geographic area and timeframes associated with the first timeframe.

In some embodiments, the parking reservation data includes a plurality of values corresponding to the plurality of peer-to-peer parking reservations and a subset of the plurality of values corresponding to the subset of the peer-to-peer parking reservations. In some embodiments, the method further includes combining the subset of the plurality of values to determine an average of the subset of the plurality of values, generating a mapping of the average of the subset of the plurality of values of one or more parking spots in the geographic area, and converting the average of the subset of the plurality of values to generate the indication of the traffic in the geographic area.

In some embodiments, generating an indication of the traffic in the geographic area includes determining the indication of the traffic based on the average of the subset of the plurality of values being substantially different than a baseline for the geographical area. In some embodiments, determining traffic in the geographical area includes determining current traffic conditions or predicting traffic at a future time.

In some embodiments, the method further includes providing the indication of the traffic in the geographic area to one of or both of the user who has reserved the parking spot or a third-party entity, wherein the third-party entity is provided the indication of the traffic in the geographic area for traffic control purposes or monitoring traffic anomalies or determining the indication of the traffic is abnormal.

In some embodiments, generating parking reservation data includes receiving an offer to reserve a parking spot from a first user of the traffic management system offering the parking spot, the offer including an identification of the parking spot and a value for which the first party is offering the parking spot for reservation, receiving an acceptance of the offer from a second user of the traffic management system, and recording a peer-to-peer parking spot reservation within the parking reservation data responsive to the acceptance of the offer.

In some embodiments, a first computing system including one or more computing devices is configured to generate the parking reservation data. In some embodiments, a second computing system including one or more computing devices is configured to determine the subset of the peer-to-peer parking reservations and generate the indication of the traffic in the geographic area, wherein the first server and the second server are communicably coupled via a community-based parking network.

Another implementation of the present disclosure is a traffic management system for determining traffic in a geographic area. The system includes one or more non-transitory computer-readable storage media having instructions stored thereon. The system further includes one or more processing circuits configured to execute instructions. The instructions include generating parking reservation data corresponding to a plurality of peer-to-peer parking reservations, each of the peer-to-peer parking reservations including a reservation by a user of the traffic management system of a parking spot offered by another user of the traffic management system. The instructions further includes determining a subset of the peer-to-peer parking reservations associated with the geographic area. The instructions further include generating an indication of the traffic in the geographic area using the parking reservation data for the subset of the peer-to-peer parking reservations associated with the geographic area.

In some embodiments, the parking reservation data includes a timeframe and a location for each of the peer-to-peer parking reservations. In some embodiments, the one or more processing circuits are further configured to determine a first timeframe for the indication of the traffic and determine the subset of the peer-to-peer parking reservations by filtering the peer-to-peer parking reservations to identify the peer-to-peer parking reservations having locations associated with the geographic area and timeframes associated with the first timeframe.

In some embodiments, the parking reservation data includes a plurality of values corresponding to the plurality of peer-to-peer parking reservations a subset of the plurality of values corresponding to the subset of the peer-to-peer parking reservations. In some embodiments, the one or more processing circuits are further configured to combine the subset of the plurality of values to determine an average of the subset of the plurality of values, generate a mapping of the average of the subset of the plurality of values of one or more parking spots in the geographic area, convert the average of the subset of the plurality of values to generate the indication of the traffic in the geographic area.

In some embodiments, generating an indication of the traffic in the geographic area includes determining the indication of the traffic based on the average of the subset of the plurality of values being substantially different than a predetermined baseline for the geographical area. In some embodiments, determining traffic in the geographical area includes determining current traffic conditions or predicting traffic at a future time.

In some embodiments, the one or more processing circuits are further configured to provide the indication of the traffic in the geographic area to one of or both of the user who has reserved the parking spot or a third-party entity, wherein the third-party entity is provided the indication of the traffic in the geographic area for traffic control purposes or monitoring traffic anomalies or determining the indication of the traffic is abnormal.

In some embodiments, for one or more of the peer-to-peer parking reservations, the one or more processing circuits are configured to generate the parking reservation data by receiving an offer to reserve a parking spot from a first user of the traffic management system offering the parking spot, the offer including an identification of the parking spot and a value for which the first party is offering the parking spot for reservation, receiving an acceptance of the offer from a second user of the traffic management system, and recording a peer-to-peer parking spot reservation within the parking reservation data responsive to the acceptance of the offer.

In some embodiments, for one or more of the peer-to-peer parking reservations, the one or more processing circuits are configured to generate the parking reservation data by receiving a request to reserve a specific parking spot or a parking spot within a defined geographic area for a specific current or future timeframe from a first user of the traffic management system, the request including an identification of a desired location and a value offered by the first party for reserving the parking spot, receiving an acceptance of the request from a second user of the traffic management system offering a parking spot meeting the desired location and accepting the value offered for reserving the parking spot, and recording a peer-to-peer parking spot reservation within the parking reservation data responsive to the acceptance of the request.

In some embodiments, the traffic management system further includes a first server configured to generate the parking reservation data and a second server configured to determine the subset of the peer-to-peer parking reservations and generate the indication of the traffic in the geographic area, wherein the first server and the second server are communicably coupled via a community-based parking network.

Another implementation of the present disclosure is a non-transitory computer-readable storage media having computer-executable instructions stored thereon that, when executed by one or more processors of a traffic management system, cause the traffic management system to perform operations. The operations include generating parking reservation data corresponding to a plurality of peer-to-peer parking reservations, each of the peer-to-peer parking reservations including a reservation by a user of the traffic management system of a parking spot offered by another user of the traffic management system. The operations further include determining a subset of the peer-to-peer parking reservations associated with the geographic area. The operations further include generating an indication of the traffic in the geographic area using the parking reservation data for the subset of the peer-to-peer parking reservations associated with the geographic area.

In some embodiments, the parking reservation data includes a timeframe and a location for each of the peer-to-peer parking reservations. In some embodiments, the one or more processing circuits are further configured to determine a first timeframe for the indication of the traffic and determine the subset of the peer-to-peer parking reservations by filtering the peer-to-peer parking reservations to identify the peer-to-peer parking reservations having locations associated with the geographic area and timeframes associated with the first timeframe.

In some embodiments, the parking reservation data includes a plurality of values corresponding to the plurality of peer-to-peer parking reservations and a subset of the plurality of values corresponding to the subset of the peer-to-peer parking reservations. In some embodiments, the one or more processing circuits are further configured to combine the subset of the plurality of values to determine an average of the subset of the plurality of values, generate a mapping of average of the subset of the plurality of values of one or more parking spots in the geographic area, convert the average of the subset of the plurality of values to generate the indication of the traffic in the geographic area.

In some embodiments, generating the parking reservation data includes receiving a request to reserve a parking spot from a first user of the traffic management system, the request including an identification of a desired location and a value offered by the first party for reserving the parking spot, receiving an acceptance of the request from a second user of the traffic management system offering a parking spot meeting the desired location and accepting the value offered for reserving the parking spot, and recording a peer-to-peer parking spot reservation within the parking reservation data responsive to the acceptance of the request.

In some embodiments, generating an indication of the traffic in the geographic area includes determining the indication of the traffic based on the average of the subset of the plurality of values being substantially different than a predetermined baseline for the geographical area, determining traffic in the geographical area includes determining current traffic conditions or predicting traffic at a future time.

### BRIEF DESCRIPTION OF THE DRAWINGS

FIG. 1 is a diagram of a community-based parking network, according to some embodiments.

FIG. 2 is a block diagram of a computing system that can be implemented in the network of FIG. 1, according to some embodiments.

FIG. 3 is an application interface for finding available parking spots which can be displayed on the application of FIG. 2, according to some embodiments.

FIG. 4 is an application interface for searching and selecting available parking spots which can be displayed on the application of FIG. 2, according to some embodiments.

FIG. 5 is an application interface for filtering search criteria for available parking spots which can be displayed on the application of FIG. 2, according to some embodiments.

FIG. 6 is an application interface for reserving a parking spot which can be displayed on the application of FIG. 2, according to some embodiments.

FIG. 7 is an application interface for displaying a completed reservation for the user who requested a parking spot which can be displayed on the application of FIG. 2, according to some embodiments.

FIG. 8 is an application interface for displaying a completed reservation for the user who offered a parking spot which can be displayed on the application of FIG. 2, according to some embodiments.

FIG. 9 is an application interface for displaying a parking spot offering which can be displayed on the application of FIG. 2, according to some embodiments.

FIG. 10 is an application interface for displaying delay functionality for reserving a parking spot which can be displayed on the application of FIG. 2, according to some embodiments.

FIG. 11 is an application interface for performing the wait functionality for reserving a parking spot which can be displayed on the application of FIG. 2, according to some embodiments.

FIG. 12 is an application interface displaying communication between a user offering a parking spot and a user requesting the parking spot, which can be displayed on the application of FIG. 2, according to some embodiments.

FIG. 13 is an application interface displaying tracking functionality of the user requesting the parking spot which can be displayed on the application of FIG. 2, according to some embodiments.

FIG. 14 is a block diagram showing how to value points in a parking spot transaction which can be implemented by the computing system of FIG. 2, according to some embodiments.

FIG. 15 is a diagram showing the architecture of a database for parking information which can be implemented by the computing system of FIG. 2, according to some embodiments.

FIG. 16 is a diagram describing processes of a traffic management as a service (TMaaS) database which can be implemented by the computing system of FIG. 2, according to some embodiments.

FIG. 17 is a diagram describing processes of a traffic management as a service (TMaaS) database which can be implemented by the computing system of FIG. 2, according to some embodiments.

FIG. 18 is a diagram showing PTI (pado Traffic Index) results from a TMaaS process which can be performed by the computing system of FIG. 2, according to some embodiments.

FIG. 19, is a diagram showing various PTI regions on a map which can be displayed via the user device of FIG. 2, according to some embodiments.

FIG. 20 is a diagram for showing various entities that can make a TMaaS request which can be implemented by the computing system of FIG. 2, according to some embodiments.

FIG. 21A is a diagram showing a heat map and traffic predictions which can be displayed on the user device of FIG. 2, according to some embodiments.

FIG. 21B is a diagram showing a heat map and traffic predictions which can be displayed on the user device of FIG. 2, according to some embodiments.

FIG. 22 is a flow diagram of a process for determining traffic in a geographic area which can be implemented by the computing system of FIG. 2, according to some embodiments.

### DETAILED DESCRIPTION

Overview

Before turning to the FIGURES, which illustrate certain exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

Referring generally to the FIGURES, systems and methods directed to a community-based parking spot sharing system for connecting users with parking spots (buyers) to those who wish to use the parking spots (sellers) are shown, according to exemplary embodiments. The parking spot sellers are able to offer future availability of the spots and users are able to reserve the future spots by directly communicating with the parking spot sellers.

In some implementations, users may download the application and, upon registering, are provided a set amount of points for free (further detail regarding the point-based transactions, according to some example embodiments, are described in further detail below in Subsection A). Users are then able to search a map or search an address in a search bar to find available parking spots. The parking spots may be provided by sellers that are leaving the parking spot or plan on leaving the parking spot in the near future.

The application may allow further filtering to find the appropriate parking spot, such as spots available at a future time, range of chosen parking location, handicapped parking spots, etc. Once a parking spot has been selected by the user (e.g., via clicking a location on the phone/website, etc.) the booking window will open and the user can view the sellers information. This can include ranking, reliability, car type, distance to parking spot, estimated time of arrival, and leaving time. The user will then select a “Book Now” button that engages the transaction between the buyer and seller.

Once a parking spot has been booked by the user and the user pays the indicated amount of points, the application may display a “ticket” to both the user and the seller. The price paid by the user may be predetermined (e.g., a set amount for that particular parking space or defined by the algorithm) or set by the buyer in the case of a parking spot request. This may allow an actual point-value to be established for the parking spots. Additionally, the ticket may act as a confirmation of the sale and a record of the user's reservation for that particular parking spot. The booking functionality may include various features that allow the user to customize the booking, such as a notification to the seller that there will be a delay in when the user will arrive, so that the seller does not leave the parking spot too early.

The parking application can further include features such as chat functionality between the buyer and seller before, during, or after a transaction. The application may also include tracking functionality that allows the seller to track the user while the user is driving to the purchased parking spot. Once the user has used the parking spot and plans on leaving presently or in the near future, the user may offer the parking spot via the application and sell the parking spot to another user for a pre-determined amount of points in the same manner as presented above.

### Community-Based Parking System

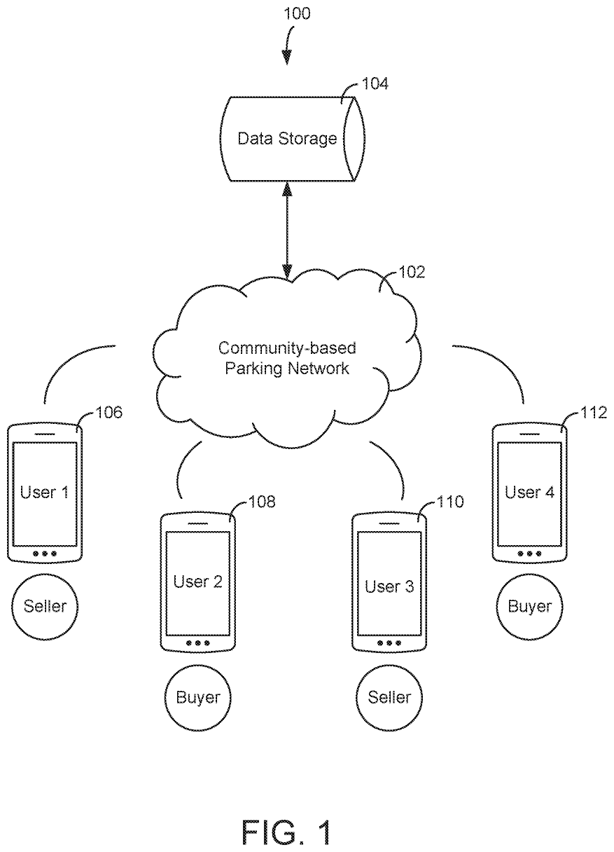

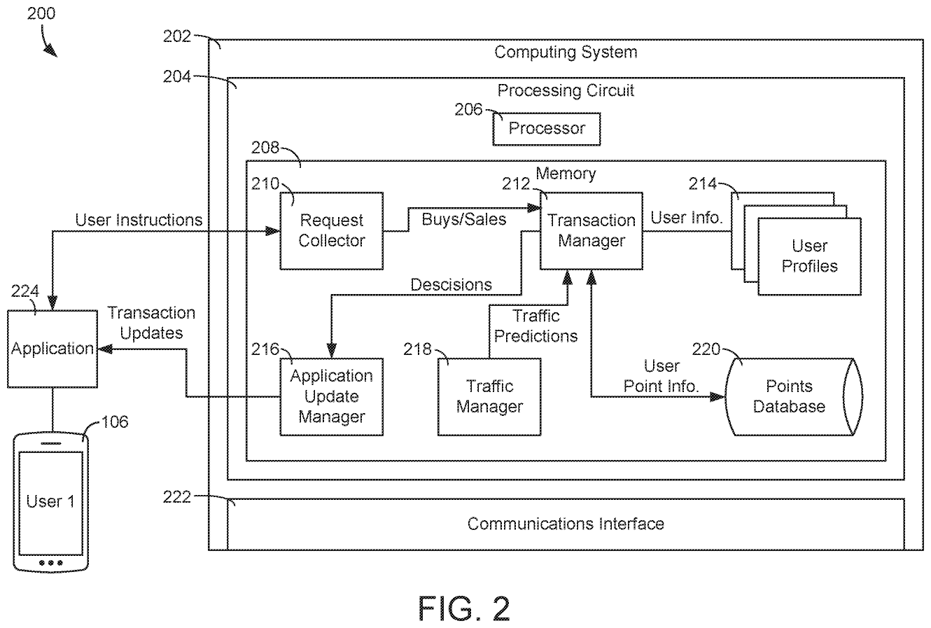

Referring generally to FIG. 1, a system 100 for providing parking requests and/or offers between users via a network is shown, according to exemplary embodiments. System 100 is shown to include community-based parking network (“network,” “the network,” etc.) 102, data storage 104, and user devices 106-112. System 100 may incorporate some or all features of various other systems described herein. For example, computing system 202 as described in FIG. 2 may be communicably connected to network 102 to perform the operations of system 100.

Network 102 may be any group of computing devices that use a set of common communication protocols over digital interconnections for the purpose of sharing resources. In some embodiments, network 102 facilitates communication between user devices 106-112, between user devices 106-112 and data storage 104, or any combination thereof. In some embodiments, network 102 may include cloud-based computing such that processing and/or data storage is performed off-premise (e.g., at different location than user devices 106-112, etc.).

Data storage 104 may be configured to store various sets and/or types of data required for operating system 100. For example, data storage 104 may store user profiles of various users of a community-based parking application that is displayed on user devices 106-112 (this is described in greater detail below with reference to FIG. 2). In other embodiments, data storage 104 may store information relating to traffic information on traffic that occurs before, during, and/or after parking transactions between the users. Data storage 104 may be configured to provide information to user devices 106-112 via a parking application (e.g., application 224 described below) upon request.

User devices 106-112 may refer to any computing device capable of communicating within system 100. In some embodiments, user devices 106-112 are smartphones capable of accessing a software application processed off-premise (e.g., Software as a Service) via a web service or processing and displaying a software application themselves. In some embodiments, user devices 106-112 are configured to access the software for application 224 that allows application 224 to be displayed on user device 106. In some embodiments, user devices 106-112 access the software via the Internet, a web browser, a local network, one or more applications, or any combination thereof. User devices 106-112 may include smartphones, tablets, computers, workstations, and/or laptops. In some embodiments, user devices 106-112 provide a parking application to a user that allows the user to request to buy or request to sell one or more parking spaces. This is shown in FIG. 1 via the labels “buyer” and “seller” for the various user devices 106-112. The functionality and processes for buying and selling a parking spot via a parking application is described in greater detail below.

Referring now to FIG. 2, a computing system 202 for processing operations for a community-based parking application is shown, according to some embodiments. While not shown in FIG. 1, computing system 202 may be communicably connected to network 102 to provide further processing and/or storage for one or more operations in system 100. Computing system 202 may include any number of servers, computing devices (e.g., processors, processing circuits, etc.) working together, cloud system functionality, cloud services, or any combination thereof. Computing system 202 is shown to include processing circuit 204 including processor 206 and memory 208 and communications interface 222.

Communications interface 222 can facilitate communications between computing system 202 and external applications/devices (e.g., application 224, user device 106, etc.) for allowing user or automatic control, monitoring, storage, and/or adjustment to computing system 202. Communications interface 222 may facilitate communications between computing system 202 and community-based parking network 102.

Communications interface 222 can be or include wired or wireless communications interfaces (e.g., jacks, antennas, transmitters, receivers, transceivers, wire terminals, etc.) for conducting data communications with HVAC equipment 630 or other external systems or devices. In various embodiments, communications via communications interface 222 can be direct (e.g., local wired or wireless communications) or via a communications network (e.g., a WAN, the Internet, a cellular network, etc.). For example, communications interface 222 can include an Ethernet card and port for sending and receiving data via an Ethernet-based communications link or network. In another example, communications interface 222 can include a Wi-Fi transceiver for communicating via a wireless communications network. In another example, communications interface 222 can include cellular or mobile phone communications transceivers. In one embodiment, communications interface 222 is a power line communications interface or Ethernet interface.

Processing circuit 204 can be communicably connected to communications interface 222 such that processing circuit 204 and the various components thereof can send and receive data via communications interface 222. Processor 206 can be a general purpose or specific purpose processor, an application specific integrated circuit (ASIC), one or more field programmable gate arrays (FPGAs), a group of processing components, or other suitable processing components. Processor 206 is configured to execute computer code or instructions stored in the memory or received from other computer readable media (e.g., CDROM, network storage, a remote server, etc.), according to some embodiments.

In some embodiments, memory 208 can include one or more devices (e.g., memory units, memory devices, storage devices, etc.) for storing data and/or computer code for completing and/or facilitating the various processes described in the present disclosure. Memory 208 can include random access memory (RAM), read-only memory (ROM), hard drive storage, temporary storage, non-volatile memory, flash memory, optical memory, or any other suitable memory for storing software objects and/or computer instructions. Memory 208 can include database components, object code components, script components, or any other type of information structure for supporting the various activities and information structures described in the present disclosure. Memory 208 can be communicably connected to processor 206 via processing circuitry 204 and can include computer code for executing (e.g., by processor 206) one or more processes described herein. Memory 208 is shown to include request collector 210, transaction manager 212, user profiles 214, application update manager 216, traffic manager 218, and points database 220.

Request collector 210 may be configured to receive user instructions relating to the application (e.g., searching for parking spots, contacting another user, etc.) and distribute the instructions appropriately. In some embodiments, request collector provides requests for purchases of the parking spots or offers for selling parking spots to transaction manager 214.

Transaction processor 212 may be configured to facilitate transactions between users. Transaction manager 212 may receive user profiles 214 that are stored either within memory 208, or off-premise at another database. Once received, transaction manager 212 may associate the intended transaction with the user profiles of the users involved in the transaction. In some embodiments, each of the user's that are using application 224 generate a user profile that is stored in user profiles 214.

User profiles 214 may include various identification information for identifying and/or characterizing a user. User profiles 212 can include general identification information, such as the user name, user location, etc. In some embodiments, this general identification information is displayed to other users, upon prior consent of the user to do so, such that users may view the user profile of other users via application 224. Various exemplary embodiments of user profiles are described in greater detail below.

Additionally, user profiles 214 may include a rating system for each of the users. For example, a user that consistently sells parking spots with few issues has a higher rating than a user who consistently offers already-taken parking spots and has several issues with his/her transactions. In some embodiments, the rating system may be facilitated by the other users using application 224. Users may be required to rate the other party after a transaction to indicate the success or difficulty in completing the transaction. A group of these ratings may categorize the user's rating onto a scale (e.g., star rating system, 1-10 scale, etc.). In some embodiments, a five-star review on a user is considered excellent, while a one-start review indicates that the user is not facilitating transactions in a proper manner.

Application update manager 216 may be configured to provide updates to application 224 based on changes occurring within computing system 202 or the parking environment outside of application 224. These updates may include updates to a world map for searching for parking spaces (e.g., received by an external maps database). In some embodiments, the updates include updating allowable parking spots, traffic conditions, construction, congested zones, or weather updates. In some embodiments, application update manager 216 includes pending transactions and completed transactions being updated in application 224. Updates implemented by application update manager 216 may be updated when the application opens on user device 106, or continuously updated throughout the day, or updated via software update patches when necessary.

Traffic manager 218 may be configured to use various pieces of data within system 200 (e.g., transaction data, weather forecasting data, etc.) to make predictions and/or inferences relating to the traffic where users are attempting to purchase/sell parking spots. In some embodiments, this processing occurs in a server (e.g., 202) off-premise such that the functionality of making traffic predictions is a software as a service (SaaS). In some embodiments, traffic manager 218 makes traffic predictions based at least in part on the prices of the transactions occurring in application 224. This is described in greater detail below. As referred to herein, this functionality may be referred to as “Traffic Management as a Service” (TMaaS).

Points database 220 may be configured to store the points information for transactions. In some embodiments, the medium of exchange for parking transactions are points, rather than actual currency. Users may be provided a set amount of points upon registration. Points are then received or used upon the selling or buying of parking spaces, respectively. Points may resemble actual currency within the application but may not have monetary value outside of application 224. In other embodiments, transactions are completed through the medium of actual currency (e.g., dollars, bitcoin, ACH transactions, etc.). In some embodiments, actual currency (e.g., via an automated clearing house (ACH) transaction, debit card transaction, credit card transaction, etc.) may be used to purchase more points. This can allow users to purchase more parking spaces if they are low on points. Additionally, if users do not want to use real money to purchase more points, yet they are low on points, users will be incentivized to sell more parking spaces.

The pricing for the parking spaces may vary based on the supply and demand of parking spaces. For example, parking spots in a downtown city near a concert venue that hosting a famous band performing in 20 minutes may see a spike in price for nearby spots as the demand is high. However, a parking spot at that same location before dawn on a Saturday may see a significant drop in prices as the demand for parking spots has decreased, thus decreasing the price of nearby parking spots.

In some embodiments, the total amount of points are capped at a certain amount such that the value of the points increases as more users register and use the application. This may be done to increase the value of the points and/or to reduce effects of inflation. In some embodiments, points are destroyed as part of the transactions, such that the number of points awarded to a seller may be less than the number of points surrendered by the buyer to reserve a spot.

In some embodiments, if users do not offer enough parking spots (e.g., or book more spots than they offer) then they may run out of points. Further bookings (e.g., purchasing parking spots) may require them to gain points by offering parking spots or by purchasing points (e.g., via PayPal, Credit Card, Apple Pay, etc.). A portion of this payment may be used to assign real value to the amount of points which are in circulation. For example, if there are 900,000 points generated at registration and 100,000 points bought additionally with real money for $0.1 per point, then all points would have a value of $10,000 ($0.01 each), assuming that 100% of payments are used to generate value to the points.

In some embodiments, the number of points in use in application 224 (e.g., in circulation) will decrease over time and hence increase its value. This may lead to creating a virtual currency (e.g., supported by real money) which can be used for purchasing parking spots directly via application 224. In some embodiments, the virtual currency can be expanded to purchase other commodities related to parking (e.g., paying vehicle battery charging, gasoline, paying for parking tickets, etc.). The aspects of point-based purchases and its effect on TMaaS is described in greater detail below.

### Application Interface Embodiments

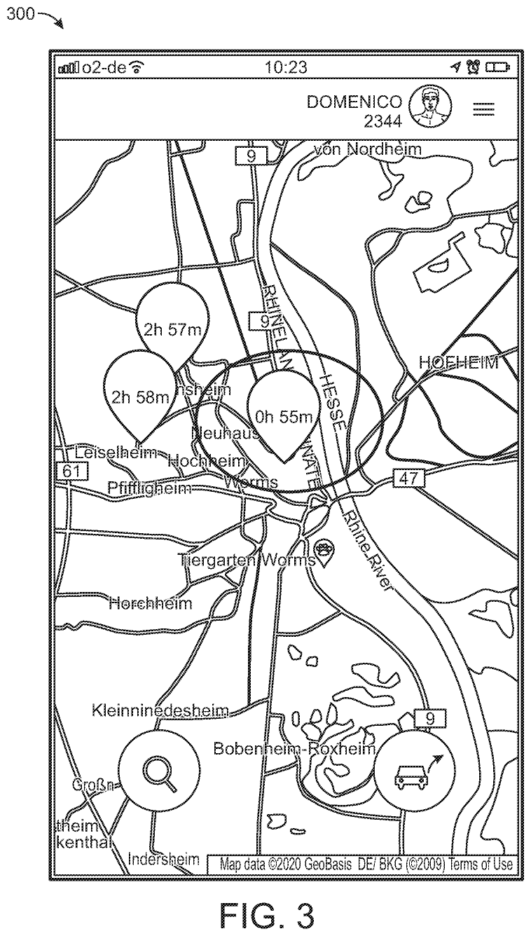

Referring now to FIGS. 3-13, various interfaces displayed on user device(s) 106 via application 224 are shown, according to exemplary embodiments. FIGS. 3-13 are merely meant to be exemplary embodiments of interfaces for application 224 and are not intended to be in any way limiting. In some embodiments, the functionality for displaying application 224 is processed at computing system 202 and is then provided to user device 106 to host application 224, rather than user device 106 storing and processing the entire application 224.

Referring now to FIG. 3, interface 300 shows a map and various parking locations and the distances to them, according to some embodiments. In some embodiments, a user may be able to scroll around the map using touch functionality (e.g., 1 finger slides the map, 2 fingers expands/contracts the map, etc.). A user may be able to directly search for a parking location or locations near a particular address by typing addresses into a search bar shown at the top of interface 300. Interface 300 may also provide a profile emblem (top-right) that indicates the current user that is signed in and the user who is selecting the one or more parking spots for purchase/selling.

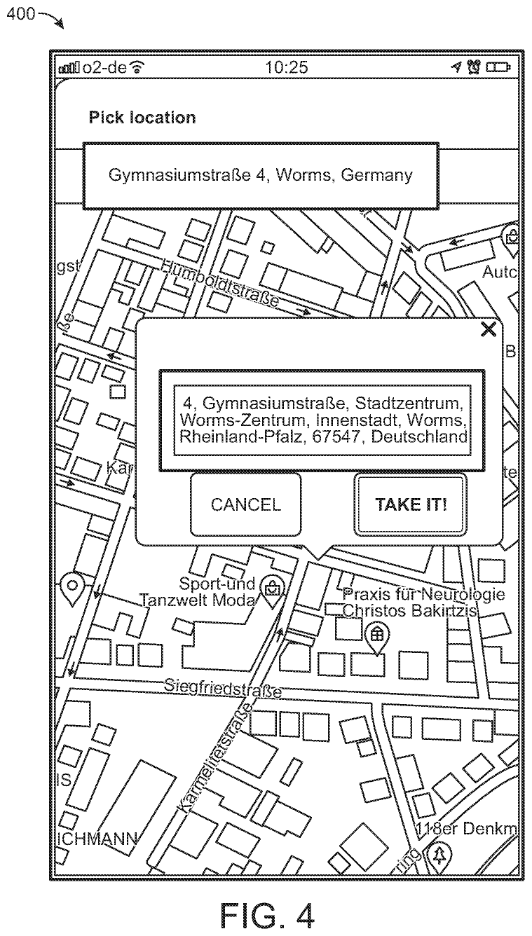

Referring now to FIG. 4, interface 400 shows an available parking spot that was discovered by typing a particular address into the search bar, according to some embodiments. In some embodiments, the detected parking spot was found and provided to interface 400 automatically due to the close proximity in which the parking spot is to the entered address. In some embodiments, interface 400 provides a window for the user to select whether the user wants to take the provided parking spot or if they want to continue searching. In some embodiments, of interface 400, the user is attempting to purchase a parking spot and is searching for an ideal parking spot near the entered address.

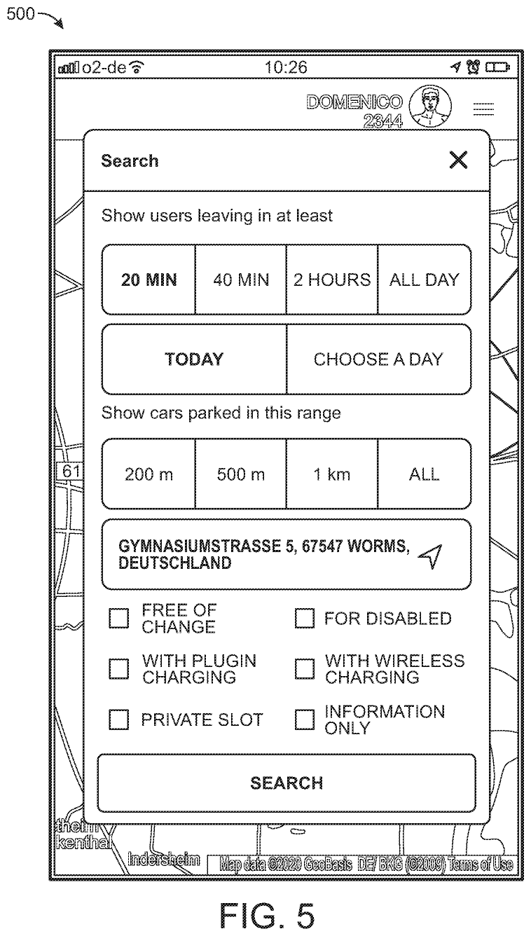

Referring now to FIG. 5, interface 500 shows filtering functionality for filtering search request for parking spots. The filtering functionality includes selecting a time period that user is planning to leave (e.g., 20 min., 40 min., 2 hours, all day, etc.), searches for different days, parking spots in a particular range (e.g., 200 m, 500 m, 1 km, no limit, etc.). In some embodiments, the filtering functionality includes even more criteria in which to filter by, such as free of charge (e.g., free parking spots), plugin charging (e.g., for electric vehicles), private parking spot, spots for disabled users, wireless charging available, and information provided about the parking spots. In some embodiments, application 224 can include various other forms of generate the most appropriate searches for a user.

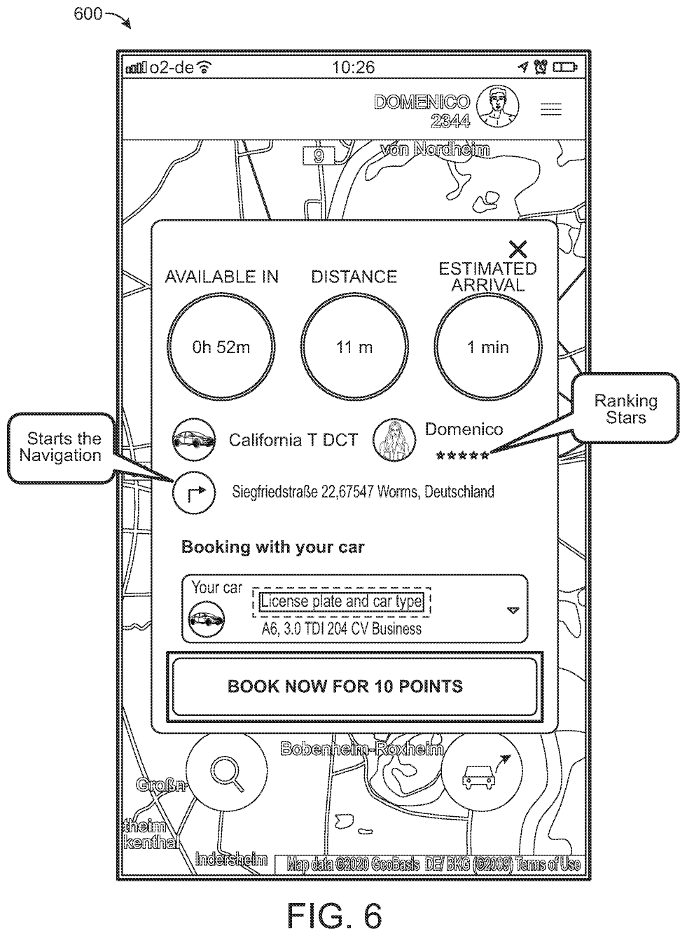

Referring now to FIG. 6, an interface 600 for showing a user booking a parking spot is shown, according to exemplary embodiments. Interface 600 shows projected parameters of the booking request (e.g., when the parking spot is available, the distance to the parking spot, the estimated time of arrival, etc.). Interface 600 can also show the various navigational tools to reach the parking spot. For example, interface 600 may provide step by step navigation to reach the parking spot. In some embodiments, application 224 pings an application programming interface (API) for map-based navigational tools to direct the user to the parking spot. In some embodiments, interface 600 includes information relating to the user's vehicle (e.g., license plate number, rating, etc.). While interface 600 may, in some embodiments, be intended for a user requesting a parking spot, a user who is selling the parking spot (“the seller”) may see similar information. For example, the seller may see the buyer's license plate information, rating, estimated time of arrival, distance to parking spot, and other criteria.

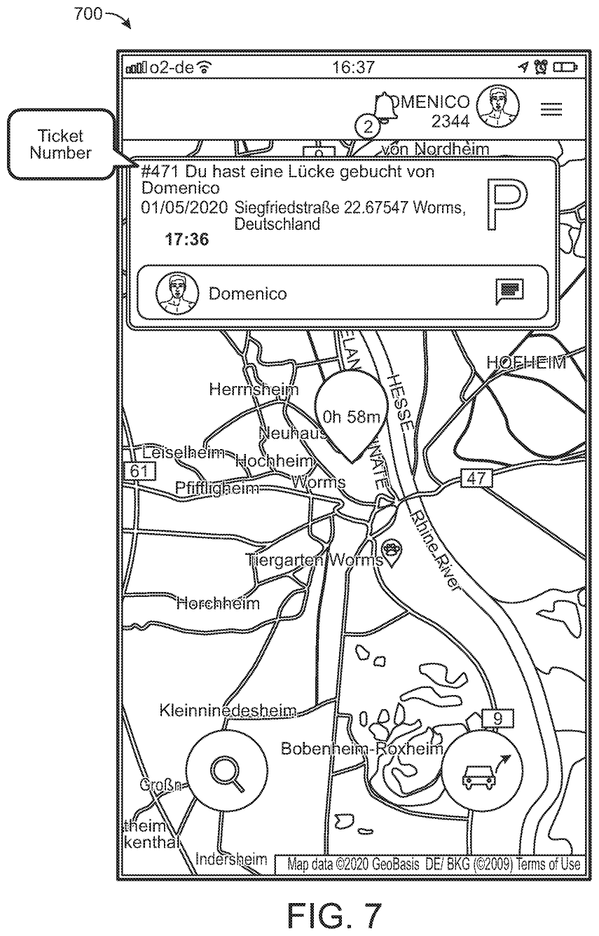

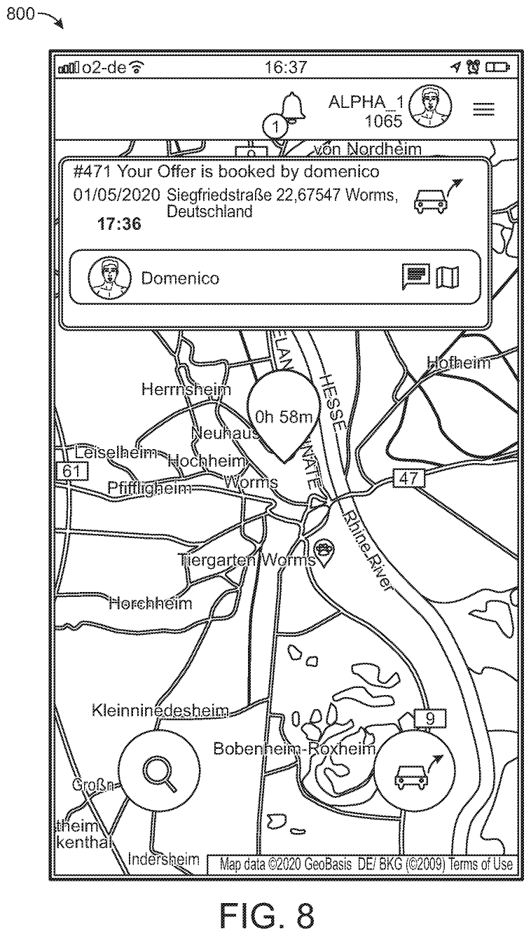

Referring now to FIGS. 7-8, interfaces 700, 800 for displaying a parking spot ticket is shown, according to some embodiments. In some embodiments, once a parking spot is booked by an agreement between the user and the seller, a ticket (e.g., receipt) may be generated for both users. In some embodiments, the tickets are identical providing identical information. In other embodiments, the tickets provide different information for the buyer and the seller. Interface 700 may show the ticket for the buyer while interface 800 may show the ticket for the seller.

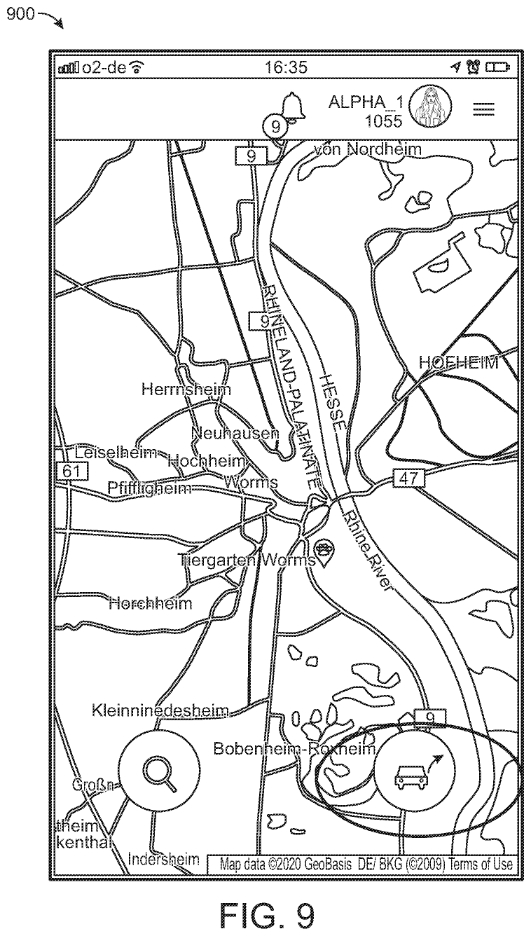

Referring now to FIG. 9, interface 900 shows features and/or functionality from a the seller's perspective. Interface 900 includes a widget that, when pressed, may allow the seller to begin the process of offering a spot. In some embodiments, application 224 knows the location of the seller and, when the widget is engaged, can automatically detect nearby parking spots that may be offered. In some embodiments, application 224 knows the location of the vehicle that is in the parking spot being sold (e.g., via a linking functionality in application 224) and can automatically detect which parking spot is going to be offered. After booking, a certain amount of points may be transferred from one user to the other. The remaining amount may transferred once the user who booked successfully parked in into the booked spot confirming hence the successful completion of the transaction between the users. In other embodiments, all points are transferred upon completion of the booking or all points are transferred after the buyer has parked.

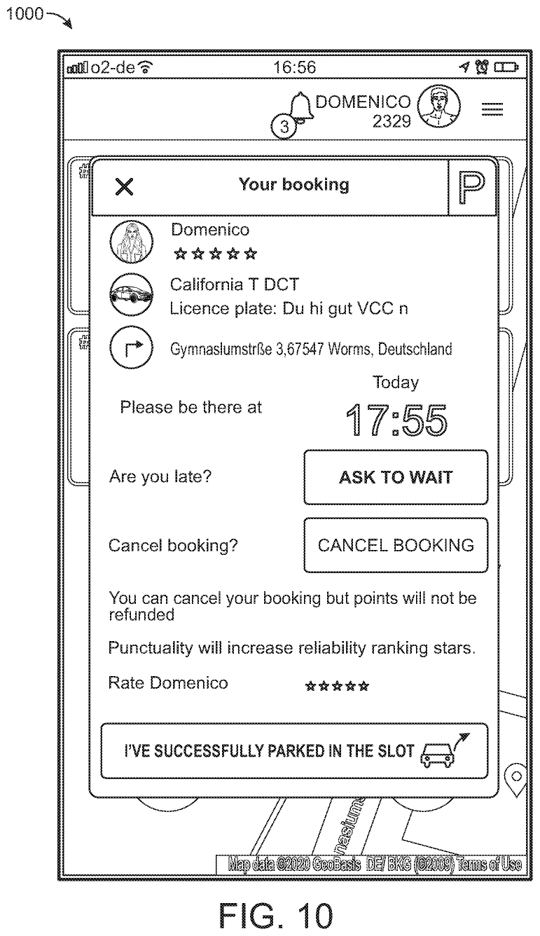

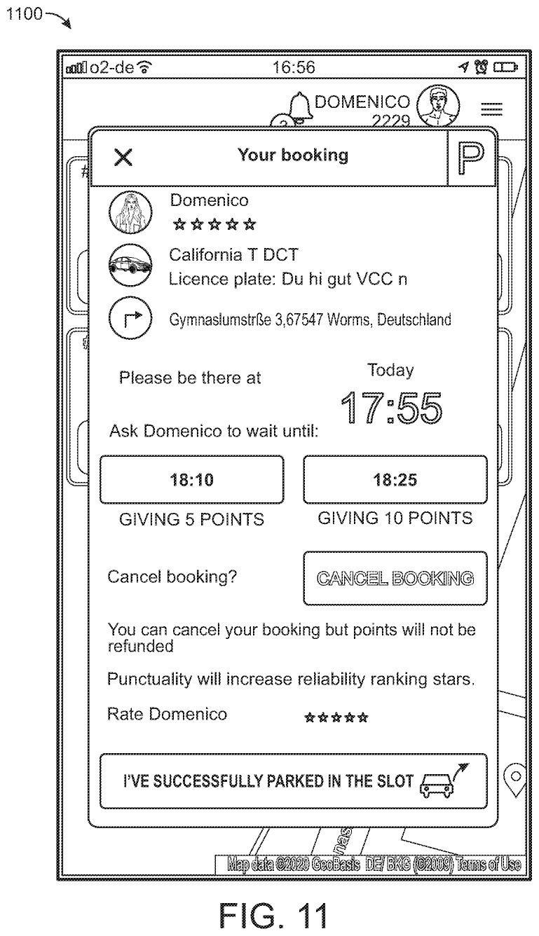

Referring now to FIGS. 10-11, interfaces 1000, 1100 showing waiting functionalities in application 224 are shown, according to some embodiments. Interface 1000 may be provided to the buyer when the buyer needs additional time to reach the offered parking spot. In some embodiments, the buyer may provide an indication that he/she is going to be late via a widget as shown in interface 1000. In some embodiments, the buyer can also cancel his booking via interface 1000 (e.g., or via other interfaces in application 224). Once parked, the buyer may indicate that he/she has successfully parked in the purchased parking spot. In some embodiments, the booking (e.g., transaction) needs to be completed prior to the wait functionality being implemented. In some embodiments, at least a portion of the finances (e.g., currency, points, etc.) needs to be transferred before the waiting functionality is implemented. In some embodiments, the buyer may need to pay for the tardiness by providing additional points to the seller, as shown in interface 1100.

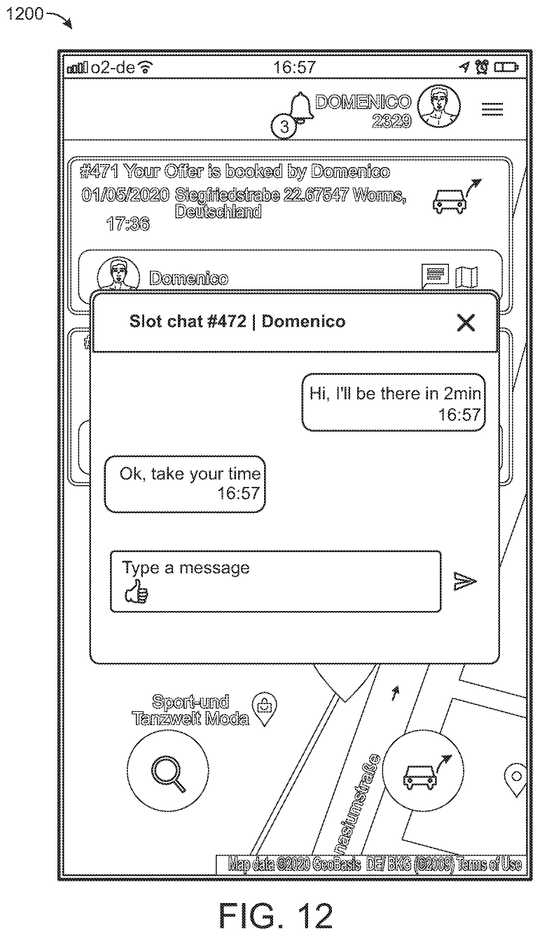

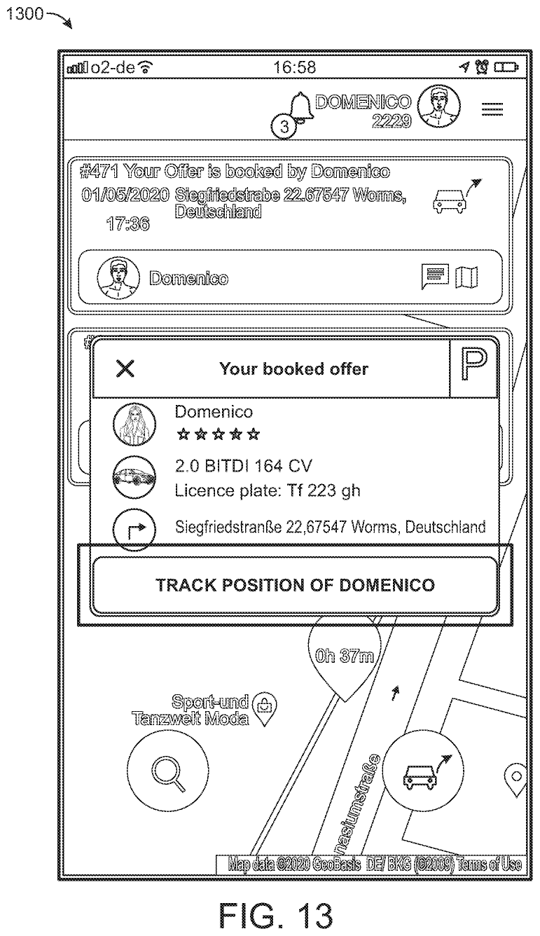

Referring now to FIG. 12, interface 1200 showing communication features between users is shown, according to some embodiments. In some embodiments, the buyer may wish to contact the seller of a parking spot before, during, and after a booked transaction, and vice versa. For example, the buyer may get lost driving to the parking spot due to incorrect direction. As such, the buyer may contact the seller for additional details on where the parking spot is located. In some embodiments, communication (e.g., texting, calling, messaging, etc.) can be performed between any and all users communicably connected to network 102. Interface 1200 shows the buyer messaging the seller that he/she will arrive in two minutes. This can provide additional assurance to the seller that the buyer is going to arrive, rather than GPS tracking via application 224, described in greater detail below with reference to FIG. 13.

Referring to FIG. 13, interface 1300 showing GPS tracking functionality is shown, according to some embodiments. In some embodiments, the seller of a parking spot may wish to track the buyer that is arriving at the purchased parking spot. As such application 224 may include GPS functionality for tracking the buyer. In some embodiments, application 224 may also include functionality to track the seller of the parking spot, in the event that predetermined directions to the parking spot are erroneous.

### Traffic Management as a Service

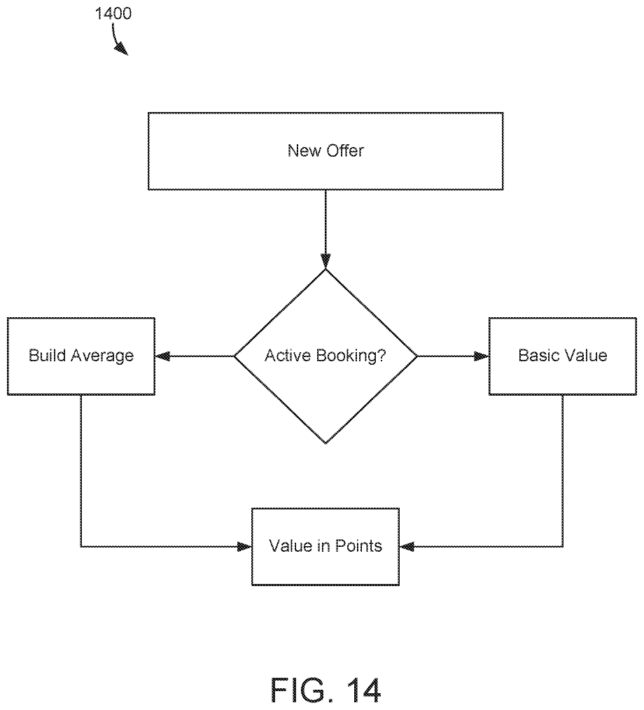

Referring generally to FIGS. 14-22, systems and methods for receiving parking transaction data and providing traffic predictions to users is shown, according to exemplary embodiments. In some embodiments, the methods and functionalities described in FIGS. 14-21 may be implemented by traffic manager 218. In other embodiments, certain methods are performed in computing system 202 and other methods are performed in a separate server. Various embodiments of this are described below.

Referring now to FIG. 14, a block diagram 1400 showing how to value points in a parking spot transaction is shown, according to exemplary embodiments. Block diagram 1400 may be configured to implement a dynamic value parking spot value algorithm that determines the value of a parking spot based on other parking spots nearby, or within system 100. Diagram 1400 shows point values for parking spots determined by combining averages (e.g., averages in points, averages in bookings) and the inherent value of the parking spot offer, which is described below.

In some embodiments, the various parking offers provided in application 224 each have an inherent point value. However, a completed transaction may be worth more points in terms of the dynamic value parking spot value algorithm. For example, the initial and basic spot value is 10 points. A theoretical first “OFFER” spot value will therefore be 10 points. It is assumed there is a deal between a User A and a User B for a spot in a specific place at a certain time (e.g., contract #1). A User C using the “REQUEST” function might offer 880 points for a spot near to the place of contract #1 and a User D will accept (e.g., contract #2). Later, a User E intends to “OFFER” a spot in that area. The point value in the above example is defined by the algorithm which considers the average of all active contracts:

$$\frac{10 + 880 + 10}{3} = 300 points$$

In some embodiments, the dynamic value parking spot value algorithm may be used in traffic management (e.g., TMaaS, in traffic manager 218, etc.). Another type of algorithm that may be used combines the average price in points with the number of bookings for parking spaces in a particular area/region. This can be defined by the following equation:

Pado Traffic Index (PTI)=Average Price in Points*Number of Bookings

In some embodiments, the Pado Traffic Index (PTI) is a value used to indicate the average (e.g., estimated) price of a parking spot in a particular region, based on the other bookings (e.g., transactions) around the region. This can be used in determining traffic predictions, as described below, along with GPS location of the various parking spots, leaving and arrival time of parking spot transactions, and time and place of bookings. In some embodiments, PTI provides insight on several users willing to “pay” a high, or a higher than usual value in points, which acts as a method to define the value of a spot at a specific point in time in the future which offers higher accuracy and reliability than other methods.

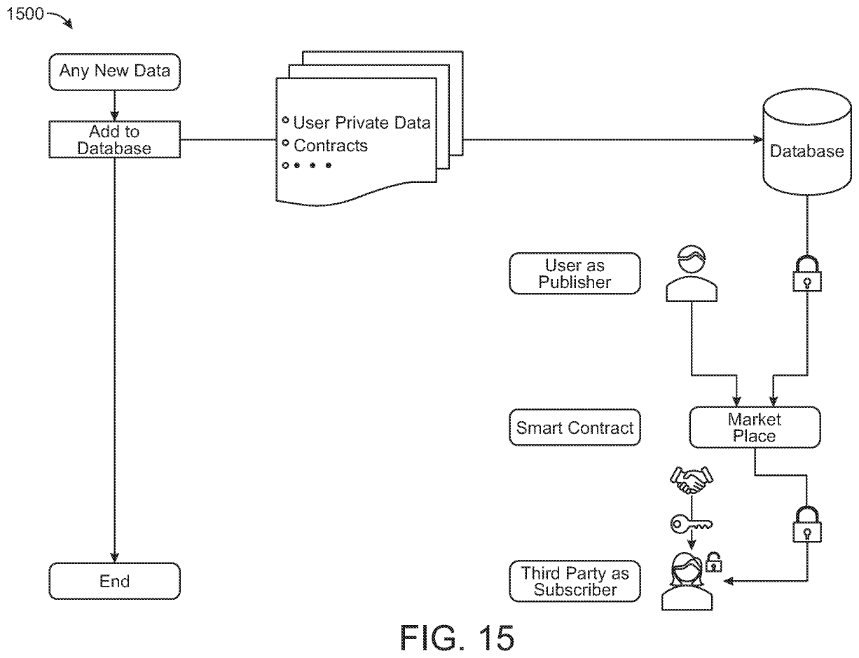

Referring now to FIG. 15, a diagram 1500 showing the architecture of a database for parking information is shown, according to exemplary embodiments. In some embodiments, diagram 1500 includes functionality that can be performed in traffic manager 218. In some embodiments, the methods and functionality described in diagram 1500 are performed in a separate server.

In some embodiments, only data that is necessary for the implementation of traffic prediction is stored in traffic manager 218. This may be done to protect certain information for users of application 224. While not shown in the FIGURES, the data for processing and implementing TMaaS may be performed in a separate server, such that the information for performing TMaaS is only using data that is necessary for its implementation, approved by the users of the user information, or both. Diagram 1500 shows new data (e.g., raw data, user private data, contracts, etc.) being stored in database, which provides limited access to other entities (e.g., third-party members, publishers, etc.).

In some embodiments, the user data which is strictly required for the TMaaS to be operational are stored on parking database servers that simultaneously store and process application 224. Other user private data may be requested and used only if the users themselves grant the insight and usage of this data to the application managers (e.g., business owners of application 224) and eventual third parties. The user will, at any time, have the full right and possibility to revoke the granted access to third parties of user data that which is not strictly required for the TMaaS to be operational.

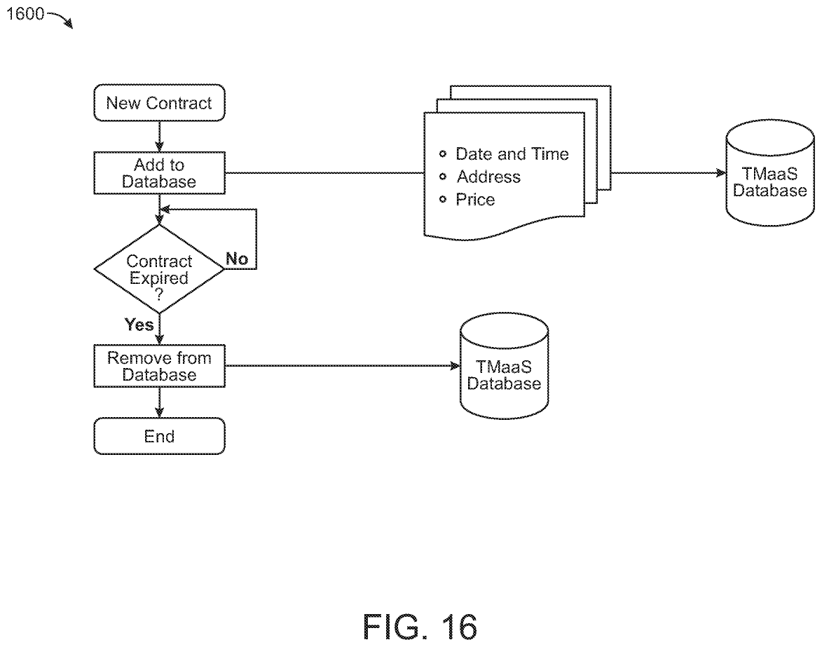

Referring now to FIG. 16, diagram 1600 describing a TMaaS database is shown, according to exemplary embodiments. Diagram 1600 shows how a TMaaS may be managed, such that information can be removed from the TMaaS database in the event that the data contract has expired. This may occur when the data is too old or is not being considered by the queries for the TMaaS data. In some embodiments, relevant data for traffic manager 218 include arrival date for the parking spot, arrival time for the parking spot, address of the parking spot, GPS information, dynamic spot value, and PTI. Below is a table of relevant data that may be provided to traffic manager 218:

| Co. | | | | |
|---|---|---|---|---|
| # | Date | Time | Address | Points |
| 1 | Jul. 26, | 8:13 | 11 Wall St, New York, NY 10005, USA | 1200 |
| | 2020 | AM | | |
| 2 | Jul. 26, | 8:15 | 72 Clinton St, New York, NY 10002, | 1300 |
| | 2020 | AM | USA | |
| 3 | Jul. 26, | 9:30 | 158 Essex St, New York, NY 10002, | 400 |
| | 2020 | AM | USA | |
| 4 | Jul. 27, | 9:18 | 349 University Ave, Newark, NJ 07102, | 40 |
| | 2020 | AM | USA | |
| 5 | Dec. 31, | 10:30 | 529 Holthouse Terrace, Sunnyvale, CA | 80 |
| | 2020 | PM | 94087, USA | |
| 6 | Dec. 31, | 11:30 | 599 Tennyson Ave, Palo Alto, CA 94301, | 900 |
| | 2020 | PM | USA | |
| 7 | Dec. 31, | 11:30 | 1515 Broadway, New York, NY 10036, | 20000 |
| | 2020 | PM | USA | |
| 8 | Dec. 31, | 11:30 | 120 W 45th St, New York, NY 10036, | 22000 |
| | 2020 | PM | USA | |

In some embodiments, a granted third party can request the pado-TMaaS data by providing one or more of the following inputs: date and time; time frame; address; radius of search area; radius of PTI. The processing of the data may be called accordingly. While date and time parameters define a starting point for the data processing, the time frame may define from when to when the data should be processed. In some embodiments, it is intended to be in plus/minus tolerance range (e.g. date and time+/−time frame) and can be defined in seconds, minutes, hours, days, months and years. In some embodiments, selecting a short time (e.g., 1 min) allows for higher accuracy. In some embodiments, while the address parameter defines a starting point of the position (e.g., address, GPS, etc.), the radius of search area defines from where to where the data should be processed.

In some embodiments, it is intended to be in a plus/minus tolerance range and can be defined in yards, meters, miles and kilometers (e.g. only Wall-Street area). It may be the area which is intended to be analyzed. The processing result of those parameters is a result (e.g., a list) of all active contracts corresponding to the defined period of time and locations. The final parameter radius of PTI defines what range (e.g., plus/minus tolerance) should be considered for the calculation of PTI. It can be defined in yards, meters, miles and kilometers. The smaller the range the more accurate and reliable the result will be. In some embodiments, it is beneficial to have a radius of (radius of PTI<radius of the search area). The final processing result may be a list or graphical representation of all matched contracts with related PTI.

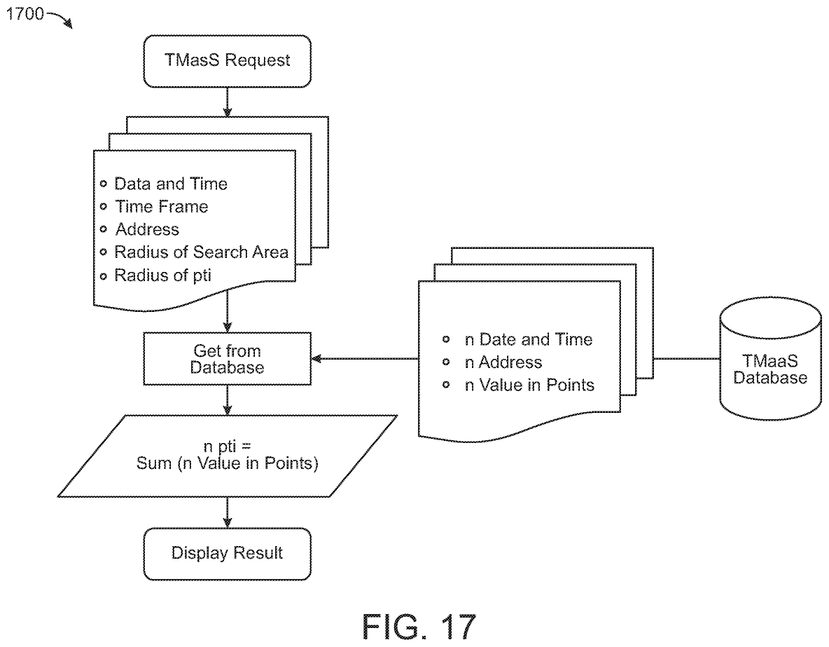

Referring now to FIG. 17, diagram 1700 showing TMaaS processing is shown according to exemplary embodiments. In some embodiments, the TMaaS processing described in diagram 1700 may be performed by traffic manager 218 either internally (e.g., within computing system 202) or externally (e.g., within another server). Diagram 1700 shows a request being made for TMaaS data, including date and time, time frame, address, radius of search area, radius of PTI, etc. This may be received by a separate TMaaS database and processed to determine TMaaS outputs, such as a PTI value for a particular location. An example of an input and output for diagram 1700 is shown below.

| | | Time | | Search | PTI |
|---|---|---|---|---|---|
| Date | Time | Frame | Address | Radius | Radius |
| Jul. 26, | 8:13 | 10 min | 11 Wall St, New York, | 1 mile | 10 |
| 2020 | AM | | NY 10005, USA | | yards |

| PTI | Address |
|---|---|
| 1200 | 11 Wall St, New York, NY |
| | 10005, USA |

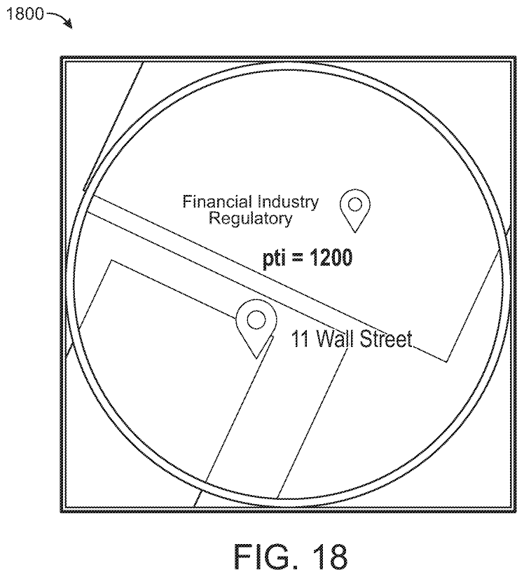

The above tables show TMaaS processing the time, time frame, search radius, and PTI radius to determine an average PTI for the New York location under the provided search radius. In some embodiments, the search radius can be expanded greatly (as shown in FIG. 18) to cover much larger regions than a particular city. In some embodiments, the PTI radius may also be expanded or decreased.

Referring now to FIG. 18, a diagram 1800 showing the PTI results from a TMaaS process is shown, according to exemplary embodiments. In some embodiments, the PTI value shows the average value for parking spots in the defined geographical area from the TMaaS request. As shown in diagram 1800, this shows the PTI in a one-mile search radius of 11 Wall St. in New York. Diagram 1800 may be configured to show the PTI for several regions that are larger or smaller than a one-mile radius.

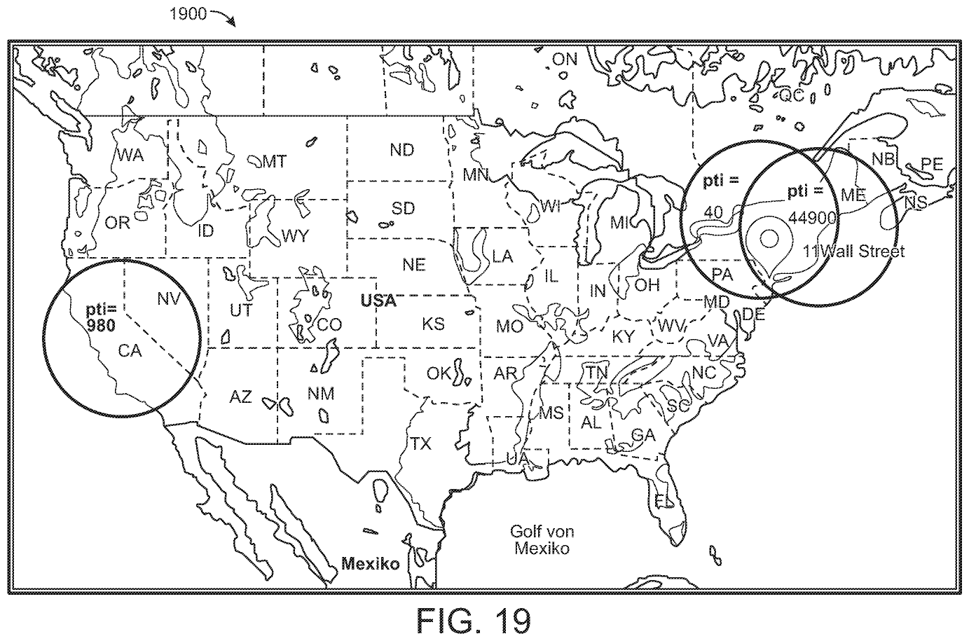

Referring now to FIG. 19, a diagram 1900 showing various PTI regions on a map is shown, according to exemplary embodiments. Diagram 1900 shows several different PTI regions for various geographical regions. Diagram 1900 shows three different PTI search results for a large search region (e.g., 4000 miles). In some embodiments, this allows a user to see the PTI values of various different geographical areas across a wider search range, compared to single geographical area.

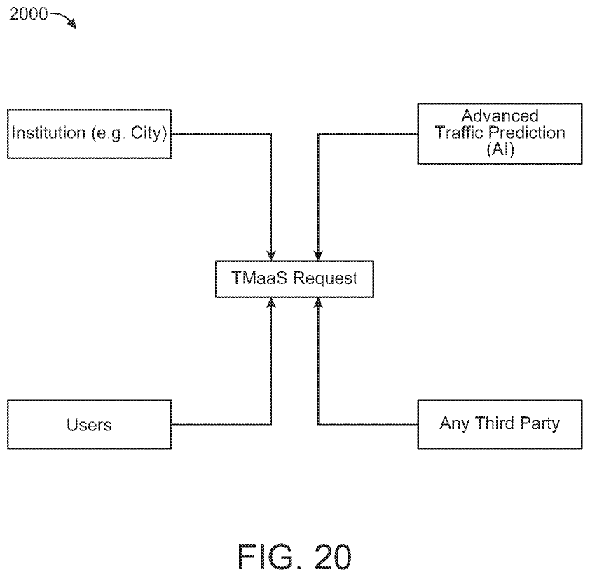

Referring now to FIG. 20, a diagram 2000 for showing various entities that can make a TMaaS request is shown, according to exemplary embodiments. In some embodiments, diagram 2000 outlines how various entities may be configured to query a TMaaS database for determining traffic predictions, including institutions (e.g., cities, municipals, towns, villages, etc.), advanced traffic predictions (AI) (e.g., computer program with AI functionality, etc.), users of application 224, and various third party entities.

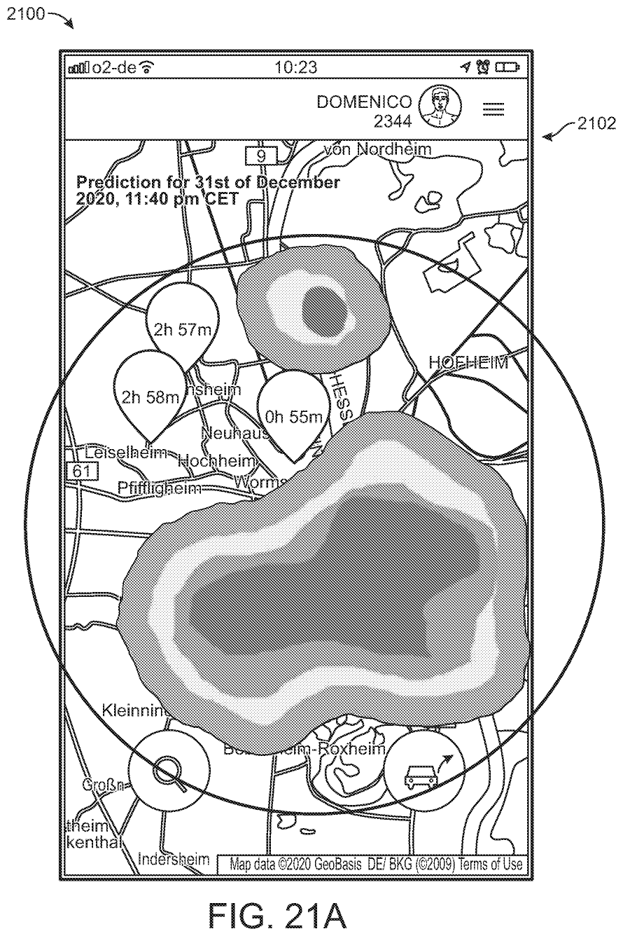

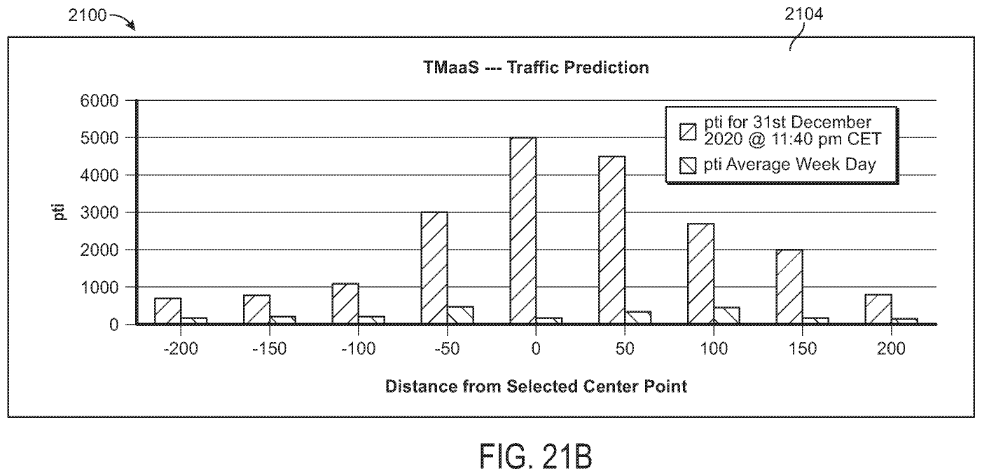

Referring now to FIG. 21, a diagram 2100 including heat map 2102 and traffic predictions graph 2104 is shown, according to exemplary embodiments. In some embodiments, heat map 2102 can combine one or more PTI results to determine a traffic intensity that displays the different traffic intensities of different geographical regions via a heat map. In some embodiments, traffic predictions graph 2104 may represent the PTI values for various distances from a selected starting point (e.g., address provided to TMaaS database). Traffic predictions graph 2104 shows the PTI value decreasing as the distance from the center point increases.

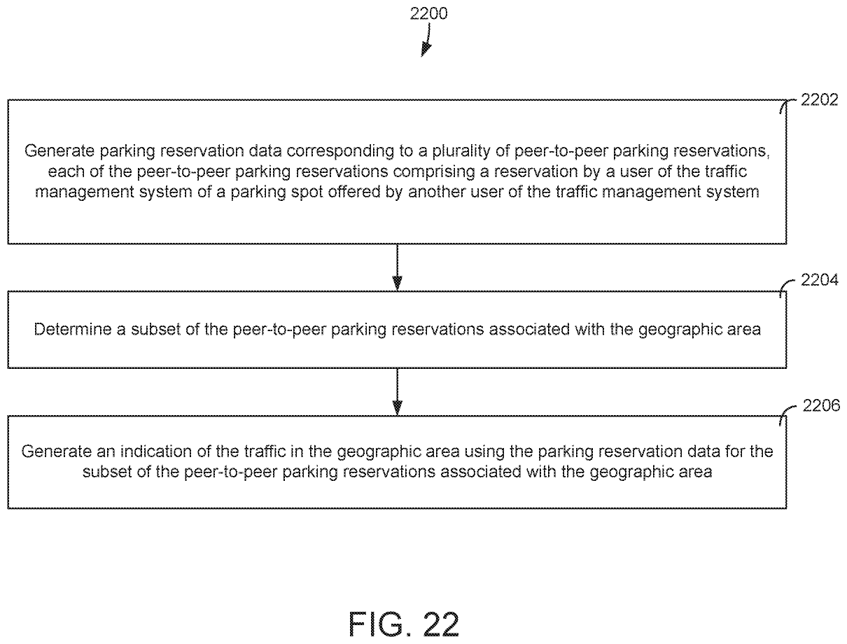

Referring now to FIG. 22, a process 2200 for determining traffic in a geographic area is shown, according to exemplary embodiments. Process 2200 may be implemented across one or more processing circuits. For example, one or more steps may be performed by a first server (e.g., computing system 202) while one or more other steps are performed by a second server (e.g., a server implementing TMaaS).

Process 2200 is shown to include generating parking reservation data corresponding to a plurality of peer-to-peer parking reservations, each of the peer-to-peer parking reservations including a reservation by a user of the traffic management system of a parking spot offered by another user of the traffic management system (step 2202). A user using application 224 may reserve a parking spot via application 224 being offered by another user (e.g., a seller) also using application 224. Based on this pending transaction, data may be generated, including the names of the user's, the time and data of the transaction, the location of the parking spot, the distance between the users, and the time it takes for the user to reach the parking spot.

Process 2200 is shown to include determining a subset of the peer-to-peer parking reservations associated with the geographic area (step 2204) and generating an indication of the traffic in the geographic area using the parking reservation data for the subset of the peer-to-peer parking reservations associated with the geographic area (step 2206). In some embodiments, the data that is generated by the peer-to-peer parking reservations can be categorized into a subset of data that represents parking information in a particular region. For example, as described above, date, time, and address, and of several parking transactions may be stored in a TMaaS database. In response to a query request, the TMaaS may provide the date, time, and address, along with a PTI value based on a determined time frame, search radius, and PTI radius. This may allow the entity who provided the query (e.g., application owner, third-party entity, etc.) to receive a PTI value in a geographical area based on the criteria provided to the TMaaS database.

In some embodiments, the parking reservation data includes a timeframe and a location for each of the peer-to-peer parking reservations, and is not provided by the user who provides the query to TMaaS database. In some embodiments, once a time frame (e.g., and other criteria such as search radius) is provided to a TMaaS database, a filtering process may occur to identify the peer-to-peer parking reservations having locations associated with the geographic area and timeframes associated with the first timeframe. This can allow a TMaaS database to consider only the necessary parking reservation data sets necessary for the geographical location during that intended time frame. In some embodiments, the TMaaS database includes modeling functionality that can compare typical traffic conditions (e.g., typical PTI values) during the given time frame and make further predictions as to traffic intensity (e.g., since the PTI value is higher than the average for this geographical area during this time frame, it can be inferred that traffic is greater at this time.)

In some embodiments, the PTI values generated by a TMaaS database may need to be mapped or configured to represent a more visual indication of traffic intensity, such as a heat map (e.g., heat map 2102). In some embodiments, this is performed by combining various average values of the parking reservation data within the geographic area to generate a mapping of average values of one or more parking spots in the geographic area. For example, the PTI values that are significantly high may represent the red color of heat map 2102 and the PTI values with significantly low values may represent the green colors of heat map 2102. In other embodiments, the configuration to map the PTI values determined for one or more geographical areas with the traffic intensity on heat map 2102 is more complex and may include further functionality, mapping, AI functionality, or any combination thereof.

In some embodiments, the process for determining the PTI values or any other indication of traffic predictions based on the peer-to-peer reservation data may include determining a baseline of traffic data. In some embodiments, modeling functionality in the TMaaS database allows for the TMaaS database to receive the reservation data and generate baseline traffic intensity for one or more geographical areas. This may be done automatically or at instances when a user provides instructions to generate traffic intensity predictions for a geographical area.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, and layers described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of various systems (e.g., system 100, system 200, etc.) and methods as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A method for determining traffic in a geographic area, the method comprising:
generating parking reservation data corresponding to a plurality of peer-to-peer parking reservations, each of the peer-to-peer parking reservations comprising a reservation by a user of a traffic management system of a parking spot offered by another user of the traffic management system;
determining a subset of the peer-to-peer parking reservations associated with the geographic area; and
generating an indication of the traffic in the geographic area using the parking reservation data for the subset of the peer-to-peer parking reservations associated with the geographic area.

2. The method of claim 1, wherein the parking reservation data comprises a timeframe and a location for each of the peer-to-peer parking reservations, and wherein the method further comprises:
determining a first timeframe for the indication of the traffic; and
determining the subset of the peer-to-peer parking reservations by filtering the peer-to-peer parking reservations to identify the peer-to-peer parking reservations having locations associated with the geographic area and timeframes associated with the first timeframe.

3. The method of claim 1, wherein the parking reservation data comprises:
a plurality of values corresponding to the plurality of peer-to-peer parking reservations; and
a subset of the plurality of values corresponding to the subset of the peer-to-peer parking reservations; and
wherein the method further comprises:
combining the subset of the plurality of values to determine an average of the subset of the plurality of values; and
generating the indication of traffic in the geographic area using the average of the subset of the plurality of values.

4. The method of claim 3, wherein:
generating an indication of the traffic in the geographic area comprises determining the indication of the traffic based on a deviation of the average of the subset of the plurality of values from a baseline for the geographical area; and
determining traffic in the geographical area comprises determining current traffic conditions or predicting traffic at a future time.

5. The method of claim 1, further comprising:
providing the indication of the traffic in the geographic area to one of or both of:
the user who has reserved the parking spot; or
a third-party entity, wherein the third-party entity is provided the indication of the traffic in the geographic area for traffic control purposes or monitoring traffic anomalies or determining the indication of the traffic is abnormal.

6. The method of claim 1, wherein generating parking reservation data comprises:
receiving an offer to reserve a parking spot from a first user of the traffic management system offering the parking spot, the offer comprising an identification of the parking spot and a value for which the first party is offering the parking spot for reservation;
receiving an acceptance of the offer from a second user of the traffic management system; and
recording a peer-to-peer parking spot reservation within the parking reservation data responsive to the acceptance of the offer.

7. The method of claim 1, wherein:
a first computing system comprising one or more computing devices is configured to generate the parking reservation data; and
a second computing system comprising one or more computing devices is configured to determine the subset of the peer-to-peer parking reservations and generate the indication of the traffic in the geographic area, wherein the first server and the second server are communicably coupled via a community-based parking network.

8. A traffic management system for determining traffic in a geographic area, the system comprising:
one or more non-transitory computer-readable storage media having instructions stored thereon; and
one or more processing circuits configured to execute the instructions to:
generate parking reservation data corresponding to a plurality of peer-to-peer parking reservations, each of the peer-to-peer parking reservations comprising a reservation by a user of the traffic management system of a parking spot offered by another user of the traffic management system;
determine a subset of the peer-to-peer parking reservations associated with the geographic area; and
generate an indication of the traffic in the geographic area using the parking reservation data for the subset of the peer-to-peer parking reservations associated with the geographic area.

9. The system of claim 8, wherein the parking reservation data comprises a timeframe and a location for each of the peer-to-peer parking reservations, and wherein the one or more processing circuits are further configured to:
determine a first timeframe for the indication of the traffic; and
determine the subset of the peer-to-peer parking reservations by filtering the peer-to-peer parking reservations to identify the peer-to-peer parking reservations having locations associated with the geographic area and timeframes associated with the first timeframe.

10. The system of claim 8, wherein the parking reservation data comprises:
a plurality of values corresponding to the plurality of peer-to-peer parking reservations; and
a subset of the plurality of values corresponding to the subset of the peer-to-peer parking reservations; and
wherein the one or more processing circuits are further configured to:
combine the subset of the plurality of values to determine an average of the subset of the plurality of values;
generate a mapping of the average of the subset of the plurality of values of one or more parking spots in the geographic area; and
convert the average of the subset of the plurality of values to generate the indication of the traffic in the geographic area.

11. The system of claim 10, wherein:
generating an indication of the traffic in the geographic area comprises determining the indication of the traffic based on the average of the subset of the plurality of values being substantially different than a predetermined baseline for the geographical area; and
determining traffic in the geographical area comprises determining current traffic conditions or predicting traffic at a future time.

12. The system of claim 8, wherein the one or more processing circuits are further configured to provide the indication of the traffic in the geographic area to one of or both of:
the user who has reserved the parking spot; or
a third-party entity, wherein the third-party entity is provided the indication of the traffic in the geographic area for traffic control purposes or monitoring traffic anomalies or determining the indication of the traffic is abnormal.

13. The system of claim 8, wherein, for one or more of the peer-to-peer parking reservations, the one or more processing circuits are configured to generate the parking reservation data by:
receiving an offer to reserve a parking spot from a first user of the traffic management system offering the parking spot, the offer comprising an identification of the parking spot and a value for which the first party is offering the parking spot for reservation;
receiving an acceptance of the offer from a second user of the traffic management system; and
recording a peer-to-peer parking spot reservation within the parking reservation data responsive to the acceptance of the offer.

14. The system of claim 8, wherein, for one or more of the peer-to-peer parking reservations, the one or more processing circuits are configured to generate the parking reservation data by:
receiving a request to reserve a parking spot from a first user of the traffic management system, the request comprising an identification of a desired location and a value offered by the first party for reserving the parking spot;
receiving an acceptance of the request from a second user of the traffic management system offering a parking spot meeting the desired location and accepting the value offered for reserving the parking spot; and
recording a peer-to-peer parking spot reservation within the parking reservation data responsive to the acceptance of the request.

15. The system of claim 8, wherein the traffic management system further comprises:
a first server configured to generate the parking reservation data;
a second server configured to determine the subset of the peer-to-peer parking reservations and generate the indication of the traffic in the geographic area, wherein the first server and the second server are communicably coupled via a community-based parking network.

16. A non-transitory computer-readable storage media having computer-executable instructions stored thereon that, when executed by one or more processors of a traffic management system, cause the traffic management system to perform operations comprising:
generating parking reservation data corresponding to a plurality of peer-to-peer parking reservations, each of the peer-to-peer parking reservations comprising a reservation by a user of the traffic management system of a parking spot offered by another user of the traffic management system;
determining a subset of the peer-to-peer parking reservations associated with the geographic area; and
generating an indication of the traffic in the geographic area using the parking reservation data for the subset of the peer-to-peer parking reservations associated with the geographic area.

17. The media of claim 16, wherein the parking reservation data comprises a timeframe and a location for each of the peer-to-peer parking reservations, and wherein the operations further comprise:
determining a first timeframe for the indication of the traffic; and
determining the subset of the peer-to-peer parking reservations by filtering the peer-to-peer parking reservations to identify the peer-to-peer parking reservations having locations associated with the geographic area and timeframes associated with the first timeframe.

18. The media of claim 16, wherein the parking reservation data comprises:
a plurality of values corresponding to the plurality of peer-to-peer parking reservations; and
a subset of the plurality of values corresponding to the subset of the peer-to-peer parking reservations; and
wherein the one or more processing circuits are further configured to:
combine the subset of the plurality of values to determine an average of the subset of the plurality of values;
generate a mapping of average of the subset of the plurality of values of one or more parking spots in the geographic area; and
convert the average of the subset of the plurality of values to generate the indication of the traffic in the geographic area of.

19. The media of claim 16, wherein generating the parking reservation data comprises:
receiving a request to reserve a parking spot from a first user of the traffic management system, the request comprising an identification of a desired location and a value offered by the first party for reserving the parking spot;
receiving an acceptance of the request from a second user of the traffic management system offering a parking spot meeting the desired location and accepting the value offered for reserving the parking spot; and
recording a peer-to-peer parking spot reservation within the parking reservation data responsive to the acceptance of the request.

20. The media of claim 16, wherein:
generating an indication of the traffic in the geographic area comprises determining the indication of the traffic based on the average of the subset of the plurality of values being substantially different than a predetermined baseline for the geographical area; and
determining traffic in the geographical area comprises determining current traffic conditions or predicting traffic at a future time.
